(19) United States
(12) Patent Application Publication
(10) Pub. No.: US 2026/0200237 A1
(43) Pub. Date: Jul. 16, 2026

(54) LIQUID DISCHARGE APPARATUS

(71) Applicant: CANON KABUSHIKI KAISHA, Tokyo (JP)

(72) Inventors: KYOKO ENDO, Kanagawa (JP); KAZUYA YOSHII, Kanagawa (JP); YOSHINORI NAKAGAWA, Kanagawa (JP)

(21) Appl. No.: 19/435,359

(22) Filed: Dec. 29, 2025

(30) Foreign Application Priority Data
Jan. 14, 2025 (JP) 2025-004943

(51) Int. Cl. B41J 2/20; B41J 2/14; B41J 2/15; B41J 2/165; B41J 2/175; B41J 2/18; B41J 29/377

(52) U.S. Cl. CPC B41J 2/20; B41J 2/14088; B41J 2/15; B41J 2/16505; B41J 2/17596; B41J 2/18; B41J 29/377

(57) ABSTRACT

A liquid discharge apparatus that comprises a liquid discharge head capable of discharging a liquid, and a circulation mechanism configured to circulate a liquid through a circulation path passing through the liquid discharge head, further comprising a sensor arranged in the apparatus, and capable of detecting temperature, wherein the circulation mechanism includes a circulation pump that is driven at a frequency based on a detection result of the sensor.

### BACKGROUND

### Field of the Technology

The present disclosure relates to a liquid discharge apparatus.

### DESCRIPTION OF THE RELATED ART

Some printing apparatuses, such as an inkjet printer, maintain ink quality by circulating ink through circulation paths in the apparatuses, thereby enabling improvement of print quality. See Japanese Patent Laid-Open No. 2019-14254.

To perform ink circulation, a circulation pump needs to be continuously driven. Therefore, it is generally difficult to achieve power saving.

### SUMMARY

The present disclosure provides a technique advantageous in achieving power saving while maintaining print quality.

An aspect of the present disclosure provides a liquid discharge apparatus that includes a liquid discharge head, a circulation mechanism including a circulation pump configured to circulate a liquid through a circulation path passing through the liquid discharge head, and a sensor arranged in the apparatus configured to detect temperature. The circulation pump configured to be driven at a frequency based on a detection result of the sensor.

Features of the present disclosure will become apparent from the following description of embodiments with reference to the attached drawings. The following description of embodiments are described by way of example.

### BRIEF DESCRIPTION OF THE DRAWINGS

FIG. 1 is a perspective view showing a part of the internal configuration of a liquid discharge apparatus according to an embodiment;

FIGS. 2A and 2B are sectional views showing the structure of a liquid discharge head;

FIG. 3 is a schematic view showing the exterior of a circulation unit;

FIG. 4 is a schematic sectional view of the liquid discharge head showing a circulation path;

FIG. 5 is a block diagram showing an example of the configuration of the circulation path;

FIGS. 6A and 6B are perspective views showing the exterior of a circulation pump;

FIG. 7 is a schematic sectional view of the circulation pump;

FIGS. 8A to 8E are schematic views for explaining the flow of ink in the liquid discharge head;

FIG. 9 is a block diagram of a control system of the liquid discharge apparatus;

FIG. 10 is a schematic plan view showing an example configuration of the liquid discharge head including a head temperature sensor;

FIG. 11 is a flowchart illustrating a method of controlling the circulation flow velocity;

FIG. 12 is an example of a reference table;

FIG. 13 is a flowchart illustrating a method of controlling the circulation flow velocity;

FIG. 14 is another example of the reference table;

FIG. 15 is a flowchart illustrating a method of controlling the circulation flow velocity;

FIG. 16 is still another example of the reference table;

FIG. 17 is a flowchart illustrating a method of controlling the circulation flow velocity;

FIG. 18 is yet another example of the reference table; and

FIG. 19 is a perspective view showing the exterior of the liquid discharge apparatus according to the embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. In the attached drawings, the same reference numerals are given to the same or similar configurations, and redundant description thereof is omitted.

### Outline of Apparatus Configuration

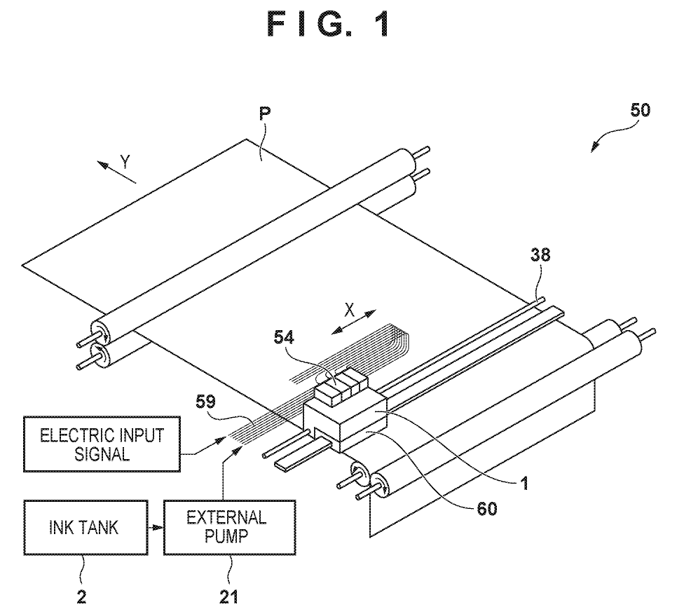

FIG. 19 is a perspective view of a liquid discharge apparatus 50 according to an embodiment. FIG. 1 is a perspective view showing a part of the internal structure of the liquid discharge apparatus 50. To facilitate the following explanation, an X direction corresponds to a left-right (widthwise) direction of the apparatus 50, a Y direction corresponds to a front-back (depth) direction of the apparatus 50, and a Z direction corresponds to a vertical (height) direction of the apparatus 50, as shown in FIG. 19. Expressions such as "upper", "lower", "left", and "right" in the following description indicate relative positional relationships between elements. Hence, for example, an upper surface (or a lower surface) may be referred to as one surface, and a lower surface (or an upper surface) may be referred to as the other surface.

The liquid discharge apparatus 50 includes a liquid discharge head 1, and executes printing on a print medium P by, while scanning the liquid discharge head 1 in a predetermined direction, discharging a liquid (typically ink, and sometimes referred to as "ink" in the following description) from each of nozzles arranged in the liquid discharge head 1. The liquid discharge head 1 may be arranged as a serial head. Alternatively, the liquid discharge head 1 may be arranged as a line head capable of printing the entire region of the print medium P in the widthwise direction at once may be used. In the case of the serial head, a flexible wiring board is used for wirings configured to supply a driving signal for discharging a liquid, a control vibration for adjusting the temperature of the head 1, and the like, and a controller configured to perform driving control of the head 1 can electrically be connected to the flexible wiring board.

Here, "printing" indicates forming an image by discharging a liquid onto the print medium P. An image may include a character, a number, a symbol, a graphic, a photo, and the like, regardless of visibility of same. From this viewpoint, the liquid discharge apparatus 50 may also be referred to as a printing apparatus, and may be an inkjet printer in embodiments in which ink is used as the liquid. Similarly, the liquid discharge head 1 can also be referred to as a printhead. A paper material can typically be used as the print medium P, but another sheet-shaped medium may be used. The liquid discharge apparatus 50 may be a copying machine that has the above-described print function as the main function and further has additional functions such as a copy function, a scanner function, and a facsimile function as sub functions.

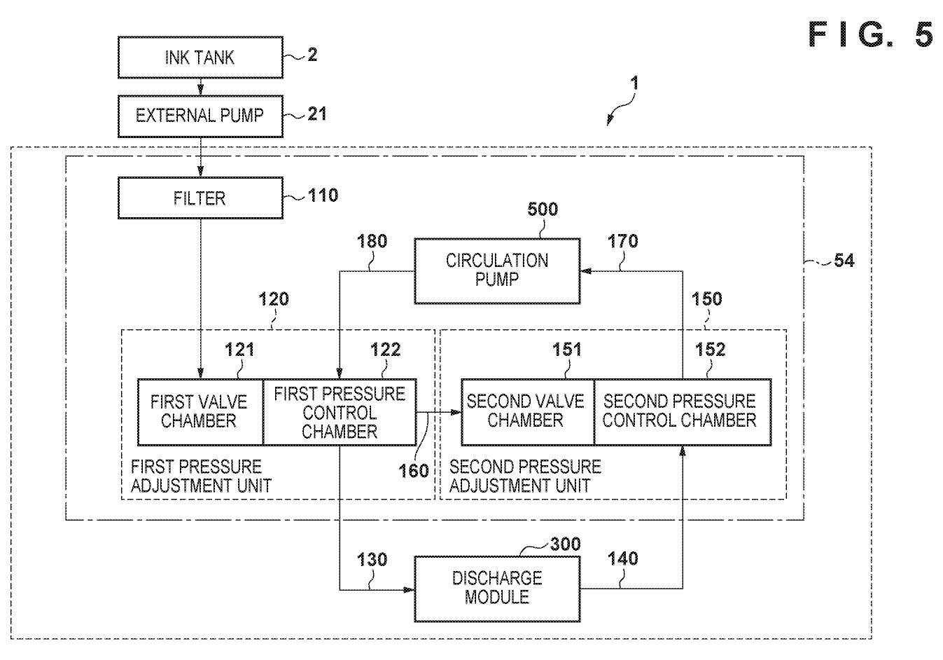

As shown in FIGS. 1 and 19, the liquid discharge apparatus 50 may include a carriage 60, a guide shaft 38, a platen 57, an ink supply tube 59, a spool 106, and an encoder 107. Ink is supplied to the liquid discharge head 1 from an ink tank 2 (FIG. 5) attached to the apparatus 50 via the ink supply tube 59 connected to the carriage 60.

The carriage 60 has the liquid discharge head 1 detachably mounted thereon, and can move along the guide shaft 38 extending in the X direction. The carriage 60 reciprocally moves and scans the liquid discharge head 1 in the X direction by receiving the power of a carriage motor.

The print medium P is sandwiched between a paper feed roller and a pinch roller and conveyed up to a position corresponding to the scan region of the liquid discharge head 1 on the platen 57, that is, a print position by the liquid discharge head 1. The spool 106 holds the print medium P so as to be conveyable in the Y direction based on a conveyance roller that rotates by receiving the power of a conveyance motor.

In a nonprinting operation (a state in which a printing operation is not actually performed), normally, the nozzle surface of the liquid discharge head 1 is capped by a cap. Hence, at the time of the printing operation, capping is canceled before the start of the printing operation, and the liquid discharge head 1 is then scanned by the carriage 60.

During the scan of the liquid discharge head 1 by the carriage 60, the liquid discharge head 1 performs a printing operation (print scan) by discharging the liquid from each nozzle at a timing according to a position signal obtained from the encoder 107. During performing printing on the print medium P, conveyance of the print medium P by a predetermined amount and suppression of the conveyance are alternately repeated (intermittent conveyance). While the conveyance of the print medium P is suppressed, by a single print scan, printing in a width (band width) corresponding to the nozzle array range is performed on the print medium P. When such single print scan and intermittent conveyance of the print medium P are alternately repeated, printing on one print medium P is completed. Printing on the next print medium P can be performed as needed in accordance with the same procedure as described above.

As another embodiment, printing for the band width may be performed by a plurality of scan times, may be performed in both the forward path and the return path of the head 1, and may be performed by printing in two or more forward paths and two or more return paths (i.e., multi-pass printing).

The liquid discharge apparatus 50 is a printer supporting color printing, and the liquid discharge head 1 can discharge inks of a plurality of colors (in this example, four colors of cyan (C), magenta (M), yellow (Y), and black (K)). However, the liquid discharge head 1 may be able to discharge an ink of a single color. If the liquid discharge head 1 can discharge inks of a plurality of colors, a plurality of heads 1 capable of discharging these may be mounted together on the carriage 60, or may be individually mounted on carriages 60. The ink colors may also be referred to as ink types since they are different in ingredients of dyes, pigments, or the like.

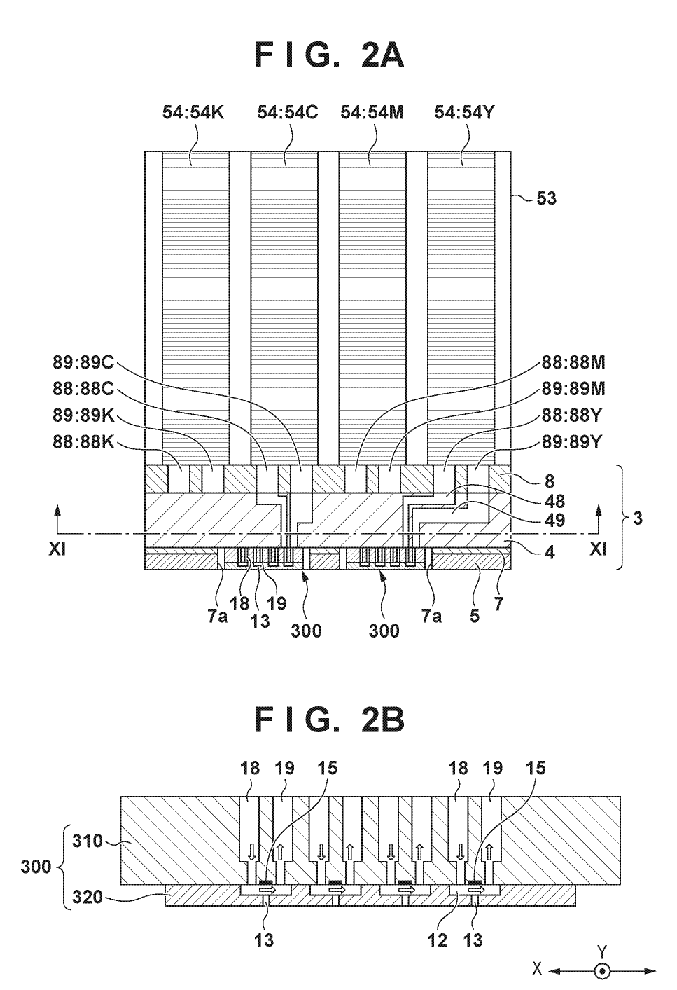

FIGS. 2A and 2B are sectional views showing the structure of the liquid discharge head 1. FIG. 2A is a sectional view of the entire liquid discharge head 1, and FIG. 2B is an enlarged sectional view of a part thereof.

In this embodiment, the liquid discharge head 1 includes circulation units 54 corresponding to respective colors, and enables circulation of inks of the respective colors supplied to the liquid discharge head 1. With this, it is possible to suppress degradation of ink quality caused by, for example, evaporation of the ink that can occur near a nozzle in an ink channel.

Here, as shown in FIG. 1, the ink supply tube 59 is connected to an external pump 21. A liquid connector can be provided at the distal end of the ink supply tube 59. If the liquid discharge head 1 is mounted in the liquid discharge apparatus 50, the liquid connector can be inserted and connected to a liquid connector insertion port provided in a housing 53 of the liquid discharge head 1. This forms an ink supply path from the ink tank 2 to the liquid discharge head 1 via the external pump 21.

As described above, in this embodiment, four types of inks C, M, Y, and K are used. Therefore, four sets of ink tanks 2, external pumps 21, ink supply tubes 59, and circulation units 54 are provided in correspondence with the four types of inks, and four ink supply paths corresponding to the inks are formed independently of each other. Thus, the liquid discharge apparatus 50 is provided with an ink supply system that supplies ink for each color from the ink tank 2 outside the liquid discharge head 1.

In FIG. 2A, a circulation unit corresponding to the K color ink is a circulation unit 54K, and similarly, circulation units corresponding to the C, M, and Y color inks are circulation units 54C, 54M, and 54Y, respectively. The circulation units 54K, 54C, 54M, and 54Y have substantially the same configuration, and will simply be referred to as the circulation unit 54 if these are not particularly discriminated in the following description.

The liquid discharge head 1 may include a discharge unit 3 configured to discharge the ink supplied from the circulation unit 54 onto the print medium P. The discharge unit 3 includes discharge modules 300, a first support member 4, a second support member 7, and an electric wiring member (electric wiring tape) 5. As shown in FIG. 2B, the discharge module 300 includes a silicon substrate 310 having a thickness of about 0.5 to 1.0 mm, and a plurality of discharge elements 15 provided on the lower surface of the silicon substrate 310. Electrothermal transducers (heaters) are typically used for the discharge elements 15, and power can be supplied to these via electric wires formed in the silicon substrate 310 using a known semiconductor process.

An orifice forming member 320 is arranged on the lower surface of the silicon substrate 310. In the orifice forming member 320, a plurality of pressure chambers 12 corresponding to the plurality of discharge elements 15, and a plurality of orifices 13 configured to discharge ink can be formed by photolithography. Also, in the silicon substrate 310, individual supply channels 18 and individual recovery channels 19 communicating with the pressure chambers 12 are formed.

In this embodiment, two discharge modules 300 are provided, as shown in FIG. 2A, and each discharge module 300 is configured to be capable of discharging two types of inks. For example, of the two discharge modules 300 shown in FIG. 2A, one discharge module 300 shown on the left side discharges the K color ink and the C color ink, and the other discharge module 300 shown on the right side discharges the M color ink and the Y color ink.

In this example, two orifice arrays extending in the Y direction are formed in correspondence with one color ink, and the pressure chamber 12, the individual supply channel 18, and the individual recovery channel 19 are formed for each of the plurality of orifices 13 forming the arrays.

Ink supply ports for supplying ink from an ink supply channel 48 to the plurality of individual supply channels 18, and ink recovery ports for recovering ink from the plurality of individual recovery channels 19 to an ink recovery channel 49 are formed in the upper surface of the silicon substrate 310. The ink supply ports and the ink recovery ports indicate openings for supplying and recovering ink circulating in the forward direction. That is, at the time of ink circulation in the forward direction, ink is supplied from the ink supply ports to the individual supply channels 18, and simultaneously, ink is recovered from the individual recovery channels 19 to the ink recovery ports. It is also possible to perform ink circulation by flowing ink in a direction reverse to the forward direction.

As shown in FIG. 2A, the discharge module 300 can be fixed, at its upper surface, to the lower surface of the first support member 4 by adhering. The ink supply channels 48 and the ink recovery channels 49 are formed in the first support member 4 to extend from the upper surface to the lower surface, and communicate with the ink supply ports and the ink recovery ports, respectively.

As shown in FIG. 2A, the second support member 7 including openings 7a for receiving the discharge modules 300 can be fixed to the first support member 4 by adhering. The second support member 7 holds the electric wiring member 5 to be electrically connected to the discharge modules 300. The electric wiring member 5 supplies an electrical signal for discharging ink to the discharge modules 300. Portions that implement electrical contention between the discharge modules 300 and the electric wiring member 5 are sealed by a predetermined sealing member and can thus be protected from corrosion by ink or external impact.

A joint member 8 can be provided between the first support member 4 and the circulation unit 54, as shown in FIG. 2A. In the joint member 8, the supply port 88 and the recovery port 89 are formed for each ink type. The supply port 88 makes the ink supply channel 48 communicate with the channel of the circulation unit 54, and the recovery port 89 makes the ink recovery channel 49 communicate with the channel of the circulation unit 54. In FIG. 2A, the supply port 88 and the recovery port 89 corresponding to the K color ink are shown as a supply port 88K and a recovery port 89K, respectively. Similarly, the supply ports 88 and the recovery ports 89 corresponding to the C, M, and Y color inks are shown as a supply port 88C and a recovery port 89C, a supply port 88M and a recovery port 89M, and a supply port 88Y and a recovery port 89Y, respectively.

In the liquid discharge head 1, the ink supplied to the circulation unit 54 flows from the ink supply port of the discharge module 300 into the individual supply channel 18 via the supply port 88 of the joint member 8 and the ink supply channel 48 of the first support member 4. The ink flows from the individual supply channel 18 into the pressure chamber 12, and a part of the ink is discharged from the orifice 13 in the pressure chamber 12 by driving of the discharge element 15. The other part of the ink (that is, the ink remaining without being discharged) flows from the pressure chamber 12 and flows from the ink recovery port of the discharge module 300 into the ink recovery channel 49 of the first support member 4 via the individual recovery channel 19. After that, the ink that flows into the ink recovery channel 49 flows into the circulation unit 54 via the recovery port 89 of the joint member 8 and is recovered. The ink is circulated in this way.

### Ink Circulation System

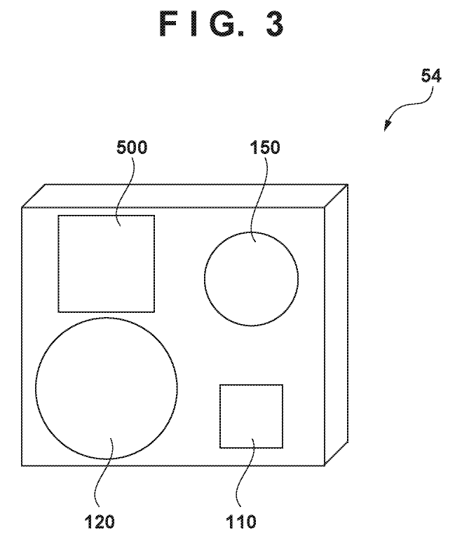

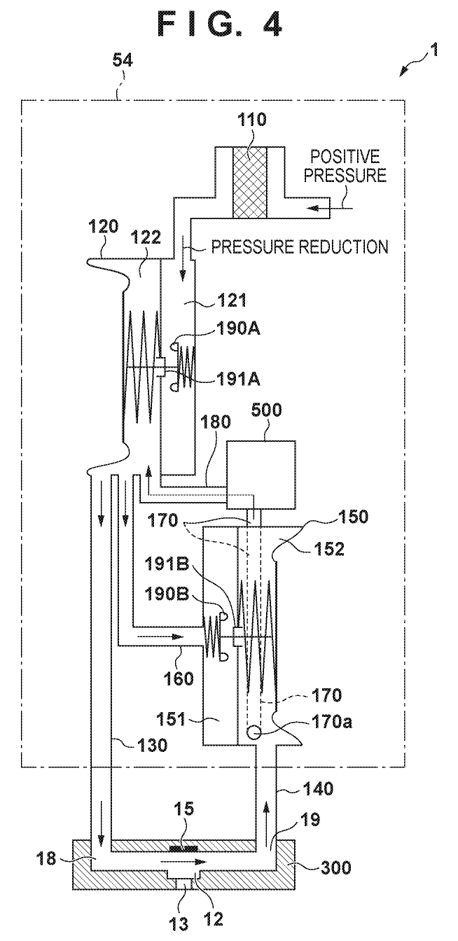

FIG. 3 is a schematic view showing the exterior of the circulation unit 54 corresponding to a certain type (color) of ink. The circulation unit 54 includes a filter 110, a first pressure adjustment unit 120, a second pressure adjustment unit 150, and the circulation pump 500. As will be described later in detail, these are connected by channels, and a circulation path configured to perform supply and recovery of ink for the discharge module 300 is formed in the liquid discharge head 1, as shown in FIGS. 4 and 5.

FIG. 4 is a schematic sectional view of the liquid discharge head 1 so as to show a circulation path for a certain type of ink. FIG. 5 is a block diagram showing an example of the configuration of the circulation path in FIG. 4.

As shown in FIGS. 4 and 5, the first pressure adjustment unit 120 includes a first valve chamber 121 and a first pressure control chamber 122, and the second pressure adjustment unit 150 includes a second valve chamber 151 and a second pressure control chamber 152. In this embodiment, ink circulation can be implemented within a predetermined pressure range using the two pressure adjustment units 120 and 150. The first pressure adjustment unit 120 is configured to have a control pressure relatively higher than in the second pressure adjustment unit 150, and ink flows near the pressure chamber 12 (or the discharge element 15) with a flow amount according to the pressure difference therebetween.

Arrows in FIG. 4 indicate the direction in which ink flows. In the following explanation, a side in the direction of ink flowing can be referred to as a downstream side, and an opposite side can be referred to as an upstream side.

As described above, the external pump 21 is connected to the ink supply tube 59 (see FIG. 1), and as shown in FIG. 5, ink is pressure-fed from the ink tank 2 to the liquid discharge head 1 and sent to the circulation unit 54. The filter 110 is provided in the ink channel on the upstream side of the circulation unit 54. The ink supply channel on the downstream side of the filter 110 is connected to the first valve chamber 121 of the first pressure adjustment unit 120.

As shown in FIG. 4, the first valve chamber 121 communicates with the first pressure control chamber 122 via a communication port 191A to be opened/closed by a valve 190A. The first pressure control chamber 122 is connected to a supply channel 130, a bypass channel 160, and a pump outlet channel 180 of the circulation pump 500. The supply channel 130 is connected to the individual supply channel 18 via the ink supply port of the discharge module 300. Also, the bypass channel 160 is connected to the second valve chamber 151 of the second pressure adjustment unit 150.

As shown in FIG. 4, the second valve chamber 151 communicates with the second pressure control chamber 152 via a communication port 191B to be opened/closed by a valve 190B. The second pressure control chamber 152 is connected to a recovery channel 140. The recovery channel 140 is connected to the individual recovery channel 19 via the ink recovery port of the discharge module 300. Also, the second pressure control chamber 152 is connected to the circulation pump 500 via a pump inlet channel 170. An element 170a shown in FIG. 4 indicates the flow-in port of the pump inlet channel 170.

The ink that is pressurized by the external pump 21 and supplied as a positive pressure ink flow to the circulation unit 54 of the liquid discharge head 1 passes through the filter 110 to remove foreign substances, and then flows into the first valve chamber 121 of the first pressure adjustment unit 120. At this time, the pressure of the ink is reduced and changed from the positive pressure to a negative pressure. The ink with the reduced pressure is supplied to the first pressure control chamber 122 and flows into the supply channel 130 and the bypass channel 160 together with the ink that is sucked from the pump inlet channel 170 on the upstream side and pressure-fed to the pump outlet channel 180 on the downstream side by the circulation pump 500.

In this embodiment, a piezoelectric diaphragm pump using a piezoelectric element adhered to a diaphragm as a driving source can be used as the circulation pump 500. The piezoelectric diaphragm pump changes the capacity in a pump chamber when a driving voltage is applied to the piezoelectric element, and alternately operates two check valves by pressure variation, thereby pressure-feeding a liquid.

The ink that flows into the supply channel 130 flows from the ink supply port of the discharge module 300 into the pressure chamber 12 via the individual supply channel 18, and a part of the ink is discharged from the orifice 13 by driving the discharge element 15. The other part of the ink (that is, the ink remaining without being discharged) flows into the recovery channel 140 via the individual recovery channel 19. The ink that flows into the recovery channel 140 flows into the second pressure control chamber 152 of the second pressure adjustment unit 150.

On the other hand, the ink that flows into the bypass channel 160 flows into the second valve chamber 151 and then flows into the second pressure control chamber 152 via the communication port 191B.

The ink that flows into the second pressure control chamber 152 is sucked into the circulation pump 500 via the pump inlet channel 170 together with the ink recovered from the recovery channel 140 by driving the circulation pump 500. The ink sucked into the circulation pump 500 is sent to the pump outlet channel 180 and flows into the first pressure control chamber 122 again.

Similarly, the ink that is supplied from the first pressure control chamber 122 to the discharge module 300 via the supply channel 130 and then flows into the second pressure control chamber 152 and the ink that flows into the second pressure control chamber 152 via the bypass channel 160 flow into the circulation pump 500. The ink is then sent from the circulation pump 500 to the first pressure control chamber 122. The ink is circulated in this way.

According to this structure, the ink can be circulated, by the circulation pump 500 provided in the liquid discharge head 1, through the circulation path formed together with the discharge module 300. When the ink is circulated, an increase of the viscosity of ink and deposition of a sedimentary component in the discharge module 300 can be suppressed, and the fluidity of ink in the discharge module 300 and the discharge characteristic at the orifice 13 can be improved. Also, ink circulation need not be executed outside the liquid discharge head 1, and using the relatively small circulation pump 500 is advantageous in reducing the size of the head 1 and the apparatus 50.

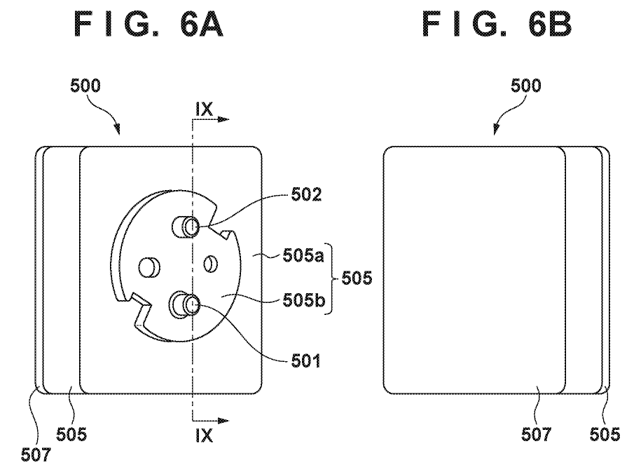

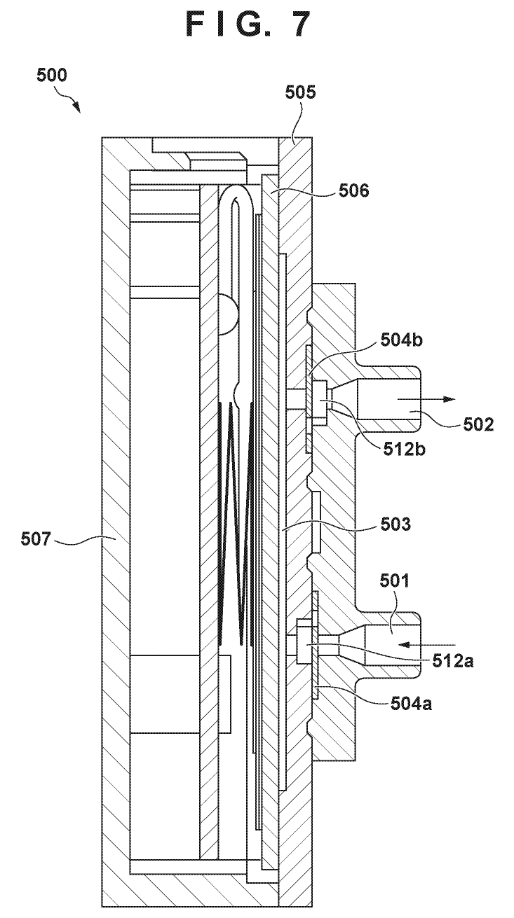

FIG. 6A is a perspective view showing the exterior of the circulation pump 500 on the front side. FIG. 6B is a perspective view showing the exterior of the circulation pump 500 on the rear side. FIG. 7 is a schematic sectional view of the circulation pump 500 taken along a line IX - IX in FIG. 6A. The exterior of the circulation pump 500 can be formed by a pump housing 505, and a cover 507 fixed to the pump housing 505.

The pump housing 505 can be formed by a housing portion main body 505a, and a channel connecting member 505b fixed to the outer surface thereof by adhering. In each of the housing portion main body 505a and the channel connecting member 505b, a pair of through holes configured to make these communicate with each other are provided at two positions different from each other. One through hole forms a pump supply hole 501, and the other through hole forms a pump discharge hole 502. The pump supply hole 501 is connected to the pump inlet channel 170 connected to the second pressure control chamber 152. The pump discharge hole 502 is connected to the pump outlet channel 180 connected to the first pressure control chamber 122. Ink supplied from the pump supply hole 501 is discharged from the pump discharge hole 502 via a pump chamber 503, as shown in FIG. 7.

A diaphragm 506 is joined to the inner wall of the pump housing 505, and the pump chamber 503 is formed between a concave portion formed in the inner wall of the pump housing 505 and the diaphragm 506. The pump chamber 503 communicates with the pump supply hole 501 and the pump discharge hole 502. Also, a check valve 504a is provided in the intermediate portion of the pump supply hole 501, and a check valve 504b is provided at the intermediate portion of the pump discharge hole 502. The check valve 504a is arranged such that a part of the check valve 504a can move to the left side in FIG. 7 in a space 512a formed in the intermediate portion of the pump supply hole 501. The check valve 504b is arranged such that a part of the check valve 504b can move to the right side in FIG. 7 in a space 512b formed in the intermediate portion of the pump discharge hole 502.

If the diaphragm 506 is displaced to increase the capacity of the pump chamber 503, and the pressure in the pump chamber 503 is thus reduced, the check valve 504a separates from the opening of the pump supply hole 501 in the space 512a (moves to the left side in FIG. 7). When the valve 504a separates from the opening of the pump supply hole 501, an open state in which ink may flow in the pump supply hole 501 is obtained. If the diaphragm 506 is displaced to decrease the capacity of the pump chamber 503, and the pressure in the pump chamber 503 is thus increased, the check valve 504a contacts the wall surface around the opening of the pump supply hole 501, and a closed state in which ink flow in the pump supply hole 501 is blocked is obtained.

On the other hand, if the pressure in the pump chamber 503 is reduced, the check valve 504b contacts the wall surface around the opening of the pump housing 505, and a closed state in which ink flow in the pump discharge hole 502 is blocked is obtained. If the pressure in the pump chamber 503 is increased, the check valve 504b separates from the opening of the pump housing 505 and moves to the side of the space 512b (the right side in FIG. 7), thereby enabling ink flow in the pump discharge hole 502.

As described above, the pump chamber 503 is formed by joining the pump housing 505 and the diaphragm 506. Hence, when the diaphragm 506 is deformed, the pressure in the pump chamber 503 changes.

For example, if the diaphragm 506 is displaced to the side of the pump housing 505 (the right side in FIG. 7), and the capacity of the pump chamber 503 is decreased, the pressure in the pump chamber 503 rises. Accordingly, the check valve 504b arranged facing the pump discharge hole 502 is set in the open state, and the ink in the pump chamber 503 is discharged. At this time, the check valve 504a arranged facing the pump supply hole 501 contacts the wall surface around the pump supply hole 501, and backflow of the ink from the pump chamber 503 to the pump supply hole 501 is suppressed.

If the diaphragm 506 is displaced in a direction of expanding the pump chamber 503, the pressure in the pump chamber 503 decreases. Accordingly, the check valve 504a arranged facing the pump supply hole 501 is set in the open state, and the ink is supplied to the pump chamber 503. At this time, the check valve 504b arranged in the pump discharge hole 502 contacts the wall surface around the opening formed in the pump housing 505 to close the opening. Hence, backflow of the ink from the pump discharge hole 502 to the pump chamber 503 is suppressed.

As described above, in the circulation pump 500, the diaphragm 506 is deformed to change the pressure in the pump chamber 503, thereby sucking and discharging the ink. At this time, in a case where bubbles are mixed into the pump chamber 503, even if the diaphragm 506 is displaced, the pressure change in the pump chamber 503 is small because of expansion/contraction of the bubbles, and therefore, the liquid feed amount decreases. To prevent this, the pump chamber 503 is arranged to extend in the vertical direction such that bubbles mixed into the pump chamber 503 easily gather to the upper portion of the pump chamber 503, and the pump discharge hole 502 is arranged above the center of the pump chamber 503. This makes it possible to appropriately discharge bubbles in the pump chamber 503 and stabilize the flow amount.

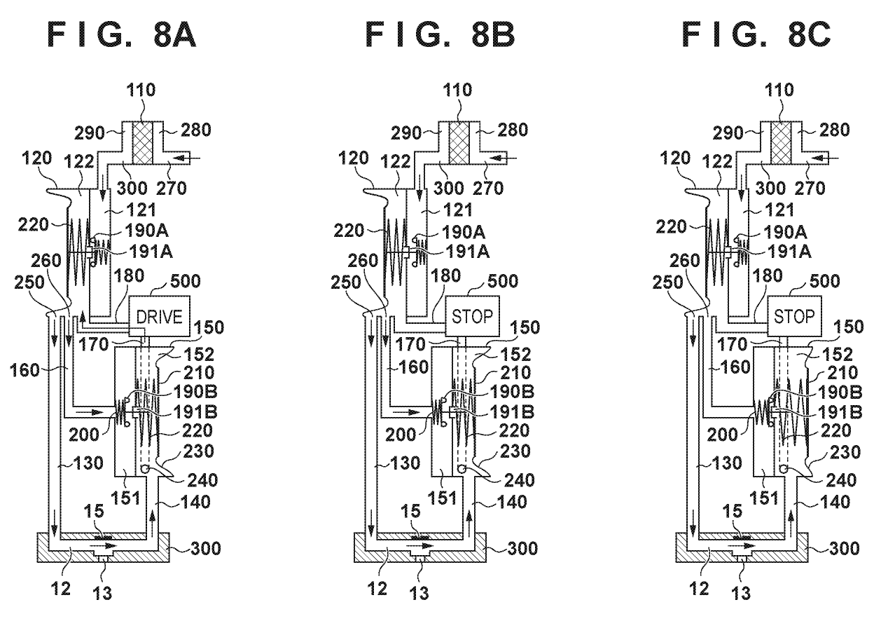

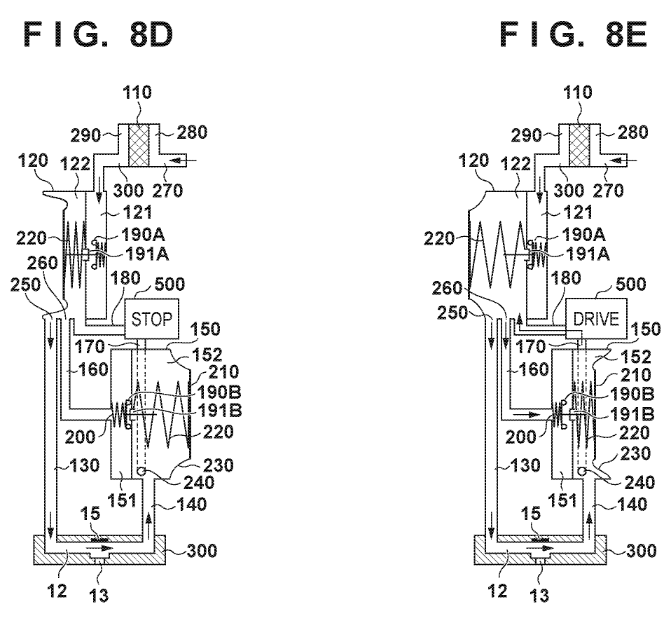

FIGS. 8A to 8E are schematic views for explaining the flow of ink in the liquid discharge head 1.

FIG. 8A shows the flow of ink during execution of the printing operation. Arrows in FIGS. 8A to 8E indicate the flow of ink. When executing the printing operation, both the external pump 21 and the circulation pump 500 start being driven. The external pump 21 and the circulation pump 500 may be driven independently of the printing operation, and may be driven separately/independently, rather than cooperatively.

During execution of the printing operation, the circulation pump 500 is in a driving state, and the ink flowed out from the first pressure control chamber 122 flows into the supply channel 130 and the bypass channel 160. The ink that flows into the supply channel 130 passes through the discharge module 300. After that, the ink flows into the recovery channel 140 and is then supplied to the second pressure control chamber 152.

On the other hand, the ink that flows from the first pressure control chamber 122 into the bypass channel 160 flows into the second pressure control chamber 152 via the second valve chamber 151. The ink that flows into the second pressure control chamber 152 passes through the pump inlet channel 170, the circulation pump 500, and the pump outlet channel 180 and then flows into the first pressure control chamber 122 again. Here, the control pressure by the first valve chamber 121 is set to be higher than the control pressure of the first pressure control chamber 122. Hence, the ink in the first pressure control chamber 122 is supplied to the discharge module 300 via the supply channel 130 again without flowing to the first valve chamber 121. The ink that flows into the discharge module 300 flows into the first pressure control chamber 122 again via the recovery channel 140, the second pressure control chamber 152, the pump inlet channel 170, the circulation pump 500, and the pump outlet channel 180.

Ink circulation is thus completed in the liquid discharge head 1.

In the ink circulation, the flow amount or circulation amount of the ink in the discharge module 300 is determined by the pressure difference (the difference of the control pressure) between the first pressure control chamber 122 and the second pressure control chamber 152. The pressure difference is set to obtain a flow amount capable of suppressing an increase of the viscosity of ink near the orifice 13 in the discharge module 300.

Also, ink as much as the amount consumed by printing is supplied from the ink tank 2 to the first pressure control chamber 122 via the filter 110 and the first valve chamber 121. When the ink in the circulation path is consumed by printing, the ink in the first pressure control chamber 122 decreases, and the internal capacity of the first pressure control chamber 122 decreases along with this. Accordingly, the communication port 191A is set in the open state, and the ink is supplied from the first valve chamber 121 to the first pressure control chamber 122. A pressure loss occurs in the supplied ink during passage from the first valve chamber 121 to the communication port 191A, and the ink in a positive pressure state changes to a negative pressure state when flowing into the first pressure control chamber 122. When the ink flows from the first valve chamber 121 into the first pressure control chamber 122, the internal capacity of the first pressure control chamber increases, and the communication port 191A is set in the closed state.

In accordance with consumption of the ink, the communication port 191A repeats the open state and the closed state. If the ink is not consumed, the communication port 191A maintains the closed state.

FIG. 8B shows the flow of ink after the printing operation is ended, and the circulation pump 500 is set in a stop state. At the point of time when the circulation pump 500 is set in the stop state, both the pressure in the first pressure control chamber 122 and that in the second pressure control chamber 152 remain the control pressures during the printing operation. For this reason, movement of ink occurs, as shown in FIG. 8B, in accordance with the pressure difference between the first pressure control chamber 122 and the second pressure control chamber 152. That is, the flow of ink is continued such that the ink is supplied from the first pressure control chamber 122 to the discharge module 300 via the supply channel 130 and then flows to the second pressure control chamber 152 via the recovery channel 140. The flow of ink from the first pressure control chamber 122 to the second pressure control chamber 152 via the bypass channel 160 and the second valve chamber 151 is also continued.

In this way, an amount of ink moved from the first pressure control chamber 122 to the second pressure control chamber 152 is supplied from the ink tank 2 to the first pressure control chamber 122 via the filter 110 and the first valve chamber 121. For this reason, the internal capacity of the first pressure control chamber 122 is maintained. If the internal capacity of the first pressure control chamber 122 is constant, the biasing force of a valve spring 200, the biasing force of a pressure adjustment spring 220, the pressure receiving area of the valve 190, and the pressure receiving area of a pressure plate 210 are kept constant. Since the pressure in the first pressure control chamber 122 is decided in accordance with the change of the pressure (gauge pressure) in the first valve chamber 121, if the pressure in the first valve chamber 121 does not change, the pressure in the first pressure control chamber 122 is kept as the same as the control pressure during the printing operation.

On the other hand, the pressure in the second pressure control chamber 152 changes over time in accordance with the change of the internal capacity along with the flow-in of the ink from the first pressure control chamber 122. That is, during the time until the state shown in FIG. 8B changes to a state shown in FIG. 8C, in which the communication port 191 is set in the closed state, and the second valve chamber 151 and the second pressure control chamber 152 are set in a noncommunicating state, the pressure in the second pressure control chamber 152 changes. After that, the pressure plate 210 and a valve shaft 190a are set in a noncontact state, and the communication port 191 changes to the closed state. Then, as shown in FIG. 8D, the ink flows from the recovery channel 140 into the second pressure control chamber 152. Accordingly, the pressure plate 210 and a flexible member 230 are displaced, and the pressure in the second pressure control chamber 152 changes and rises until the internal capacity of the second pressure control chamber 152 is maximized.

If the state shown in FIG. 8C is obtained, the flow of ink from the first pressure control chamber 122 to the second pressure control chamber 152 via the bypass channel 160 and the second valve chamber 151 does not occur. Hence, after the ink in the first pressure control chamber 122 is supplied to the discharge module 300 via the supply channel 130, only the flow to the second pressure control chamber 152 via the recovery channel 140 may substantially occur. As described above, the movement of ink from the first pressure control chamber 122 to the second pressure control chamber 152 occurs due to the pressure difference between the first pressure control chamber 122 and the second pressure control chamber 152. For this reason, if the pressure in the second pressure control chamber 152 equals the pressure in the first pressure control chamber 122, the movement of ink stops.

In a state in which the pressure in the second pressure control chamber 152 equals the pressure in the first pressure control chamber 122, the second pressure control chamber 152 expands up to the state shown in FIG. 8D. If the second pressure control chamber 152 expands, a storage portion capable of storing ink is formed in the second pressure control chamber 152. The time from the stop of the circulation pump 500 until transition to the state shown in FIG. 8D is about 1 to 2 min, depending on the shape and size of each channel and the characteristic of the ink.

If the circulation pump 500 is driven from the state shown in FIG. 8D in which the storage portion is formed in the second pressure control chamber 152 to enable storage of the ink, the ink in the storage portion is supplied to the first pressure control chamber 122 by the circulation pump 500. Thus, as shown in FIG. 8E, the ink amount in the first pressure control chamber 122 increases, and the flexible member 230 and the pressure plate 210 are displaced in the expanding direction. When driving of the circulation pump 500 is continued, the state in the circulation path changes, as shown in FIG. 8A.

FIG. 8A has been exemplified above as a mode during execution of the printing operation. However, ink circulation may be performed without the printing operation, as described above. In this case as well, the ink flows, as shown in FIGS. 8A to 8E, in accordance with driving and stop of the circulation pump 500.

In this embodiment, a mode has been exemplified in which the communication port 191B of the second pressure adjustment unit 150 is set in the open state when the ink is circulated by driving the circulation pump 500, and set in the closed state when the ink circulation is stopped. However, the present disclosure is not limited to this. For example, the control pressure may be set such that even if the ink is circulated by driving the circulation pump 500, the communication port 191B of the second pressure adjustment unit 150 is set in the closed state.

The bypass channel 160 that connects the pressure adjustment units 120 and 150 can be provided such that, for example, if a negative pressure generated in the circulation path is higher than usual/higher than a reference, it is prevented from substantially affecting the discharge module 300. For example, if the characteristic (viscosity or the like) of ink changes due to a change of an environment such as a temperature, the pressure loss in the circulation path also changes. For example, if the viscosity of ink is reduced, the pressure loss in the circulation path decreases, and the negative pressure in the circulation path can be higher than usual. Along with this, outside air may be drawn from the orifice 13 into the circulation path and break the meniscus of the orifice 13, and it may be impossible to appropriately perform discharge. Hence, in this embodiment, the bypass channel 160 is provided in the circulation path.

According to the bypass channel 160, if the negative pressure is higher than usual, ink flows to the bypass channel 160 as well, and the pressure in the discharge module 300 can be maintained. For example, the communication port 191 of the second pressure adjustment unit 150 can be configured to obtain a control pressure capable of maintaining the closed state even during driving of the circulation pump 500. If the negative pressure is high, the control pressure of the second pressure adjustment unit may be set such that the communication port 191 is set in the open state.

Also, since a force of drawing ink is generated in the pressure chamber due to the discharge operation by the discharge element 15, the pressure variation in the circulation path may occur in the discharge operation as well. Hence, for example, even if the communication port 191 of the second pressure adjustment unit 150 is configured to be set in the closed state during driving of the circulation pump 500, the communication port 191 may be in the open state at the time of the discharge operation. For example, if printing with a relatively high duty ratio is continued, the negative pressure in the pressure chamber may be high. Accordingly, the ink moves even from the side of the recovery channel 140 to the pressure chamber (orifice 13), that is, backflow of ink occurs (this backflow can occur because the bypass channel 160 is provided). Thus, the ink in the second pressure control chamber 152 decreases, and the second pressure control chamber 152 is reduced. As a result, the communication port 191 of the second pressure adjustment unit 150 may be set in the open state. In this case, the ink in the supply channel 130 and the ink in the recovery channel 140 are filled and discharged to the pressure chamber.

In the above-described explanation, a mode in which the communication port 191 of the second pressure adjustment unit 150 is set in the open state in accordance with the backflow of ink has been shown. The backflow of ink may occur in a case where the communication port 191 of the second pressure adjustment unit 150 is in the open state. Also, even in a configuration without the second pressure adjustment unit 150, the backflow of ink can occur when the bypass channel 160 is provided.

The above-described circulation path for ink passing through the liquid discharge head 1 and components for causing ink to circulate through the circulation path may be collectively referred to as a circulation mechanism.

### Control System of Apparatus

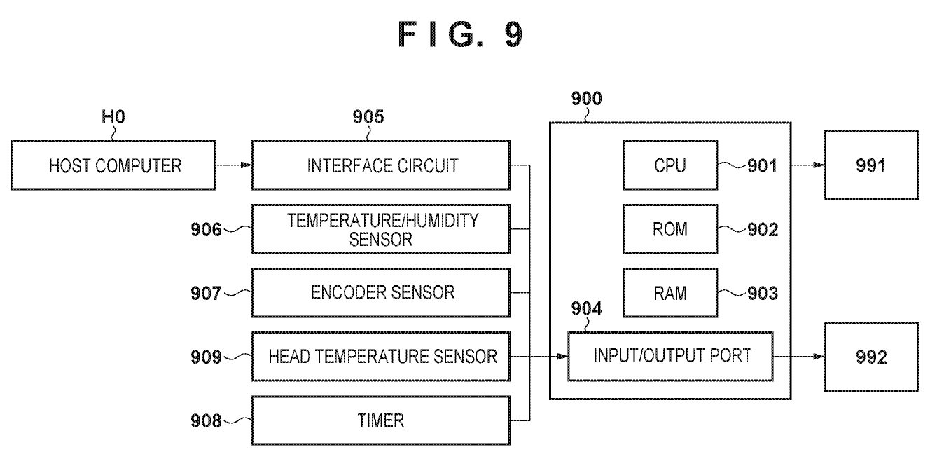

FIG. 9 is a block diagram of a control system of the liquid discharge apparatus 50. The liquid discharge apparatus 50 includes a main control unit 900, an interface circuit 905, a temperature/humidity sensor 906, an encoder sensor 907, a timer 908, a head temperature sensor 909, a counter group 991, and a driver group 992.

The main control unit 900 includes a Central Processing Unit (CPU) 901, a Read-Only Memory (ROM) 902, a Random Access Memory (RAM) 903, and an input/output port 904. The main control unit 900 exchanges signals with external elements via the input/output port 904. For example, in response to a print job input from a host computer H0 via the interface circuit 905, the CPU 901 executes a predetermined program read out from the ROM 902 and deploys intermediate data and the like on the RAM 903, thereby implementing the print function.

The CPU 901 can control the driver group 992 to, for example, perform driving control of the above-described conveyance motor, carriage motor, and the like, and drive the liquid discharge head 1 at the same time. In addition, the CPU 901 can control the driver group 992 to perform driving control of the circulation pump 500 to circulate ink. The CPU 901 can control the driver group 992 to drive a known recovery unit for recovering the print function of liquid discharge head 1.

Based on detection results of the temperature/humidity sensor 906, the encoder sensor 907, the timer 908, and/or the head temperature sensor 909, the CPU 901 can execute the above-described driving or control. For example, ink circulation by the circulation pump 500 can be controlled based on the detection result thereof.

### First Example

As described above, in a printing operation, capping of the liquid discharge head 1 is canceled. Therefore, ink circulation is performed to eliminate an increase of the viscosity of ink caused by evaporation near the nozzle. As an example, the CPU 901 can perform driving control of the circulation pump 500 based on the temperature of the liquid discharge head 1 detected by the head temperature sensor 909, thereby controlling, for example, the circulation flow velocity of ink (the travel distance of ink per unit time in the circulation path).

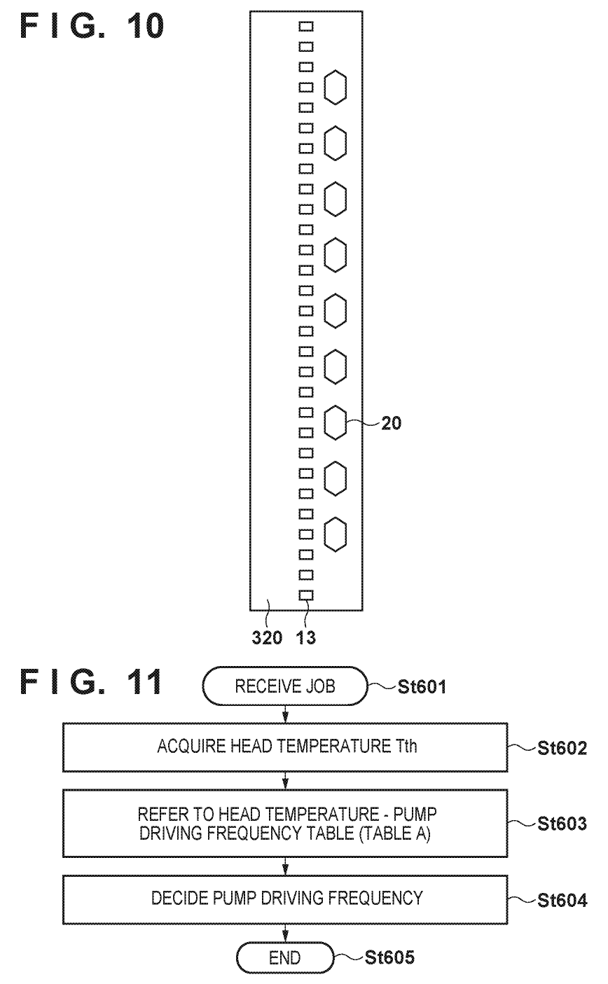

FIG. 10 is a schematic plan view of the orifice forming member 320 in which diodes 20 are arranged near the orifices 13 as an example of the head temperature sensor 909. If the circulation flow velocity is below a reference, the viscosity of ink may increase and the ink may adhere in the circulation path. Therefore, it is required to maintain constant circulation flow velocity at or above the reference.

Since the viscosity of ink increases when moisture of ink evaporates, the higher the temperature of the liquid discharge head 1, the more the viscosity of ink tends to increase through evaporation. Therefore, it can be generally necessary to increase the circulation flow velocity.

FIG. 11 shows a flowchart of a method of controlling the circulation flow velocity according to the first example. Each step of this flowchart is executed mainly by the CPU 901.

In step St601, a print job transmitted from the host computer H0 is received, to start the method.

In step St602, the head temperature sensor 909 acquires the temperature of the liquid discharge head 1 as a head temperature Tth.

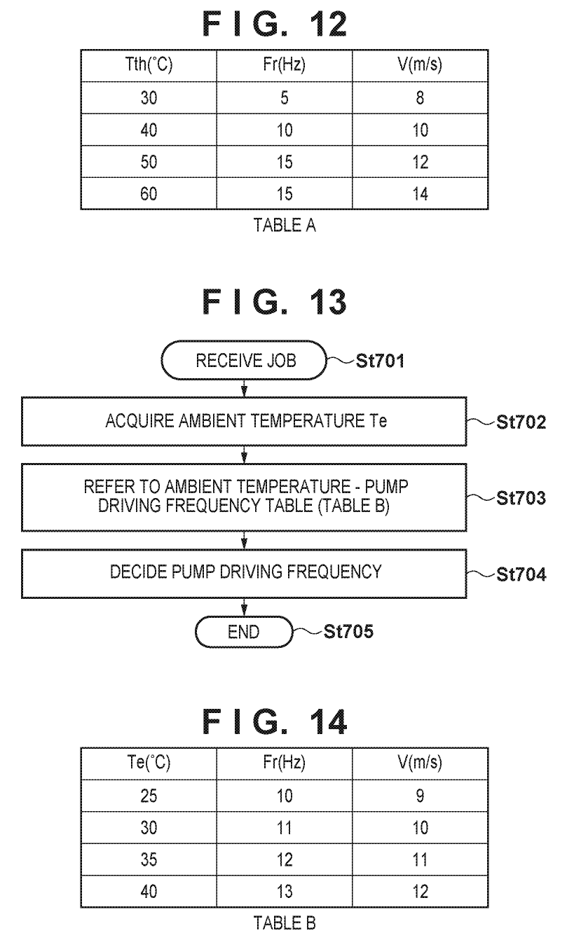

In step St603, a table A exemplarily shown in FIG. 12 is referred to. In step St604, a driving frequency Fr of the circulation pump 500 corresponding to the head temperature Tth acquired in step St602 is decided. In step St605, this method ends. In this embodiment where a piezoelectric diaphragm pump is used as the circulation pump 500, the driving frequency Fr can correspond to the number of displacements of the diaphragm 506 per unit time.

Here, the table A is stored in the ROM 902. The Table A is preset with the driving frequency Fr of the circulation pump 500 corresponding to arbitrary head temperature Tth. As described above, in general, the higher the temperature of the liquid discharge head 1, the higher the required circulation flow velocity. Therefore, the table A is preset with a circulation flow velocity V and the corresponding driving frequency Fr that can eliminate an increase of the viscosity of ink which can occur at the head temperature Tth. Typically, when the head temperature Tth is high, the driving frequency Fr can be decided to a relatively high value.

If the ink temperature further rises, the viscosity of ink is reduced, and therefore the circulation flow velocity may become higher even at the same driving frequency Fr. In the table A, the required circulation flow velocity V is set to 12 m/s when the head temperature Tth is 50 °C, and the required circulation flow velocity V is set to 14 m/s when the head temperature Tth is 60 °C. In this example, the driving frequency Fr for achieving these is 15 Hz in both cases.

According to the first example, it is possible to appropriately implement ink circulation in a printing operation, thereby preventing/eliminating an increase of the viscosity of ink caused by evaporation near the nozzle. That is, ink quality can be maintained, and this can lead to improvement of print quality. Since the ink circulation is performed by driving the circulation pump 500 with a driving force corresponding to the head temperature Tth, according to the first example, ink circulation is neither performed unnecessarily nor excessively.

### Second Example

The CPU 901 can perform driving control of the circulation pump 500 based on the ambient temperature of the liquid discharge apparatus 50 (the temperature around the liquid discharge apparatus 50) detected by the temperature/humidity sensor 906, thereby controlling, for example, the circulation flow velocity of ink. Since the viscosity of ink increases when moisture of ink evaporates, the higher the ambient temperature, the more the viscosity of ink tends to increase through evaporation. Therefore, it is necessary to increase the circulation flow velocity.

FIG. 13 shows s a flowchart of a method of controlling the circulation flow velocity according to the second example.

In step St701, a print job transmitted from the host computer H0 is received, and the method is started.

In step St702, the temperature/humidity sensor 906 acquires the ambient temperature of the liquid discharge apparatus 50 as an ambient temperature Te.

In step St703, a table B exemplarily shown in FIG. 14 is referred to. In step St704, the driving frequency Fr of the circulation pump 500 corresponding to the ambient temperature Te acquired in step St702 is decided. In step St705, the method ends. Similar to the table A described in the first example, the table B is stored in the ROM 902. The table B is preset with the driving frequency Fr of the circulation pump 500 corresponding to arbitrary ambient temperature Te. Thus, an effect similar to the effect in the first example can be achieved.

### Third Example

The CPU 901 can perform driving control of the circulation pump 500 based on the ambient humidity of the liquid discharge apparatus 50 (the humidity around the liquid discharge apparatus 50) detected by the temperature/humidity sensor 906, thereby controlling, for example, the circulation flow velocity of ink. Since the viscosity of ink increases when moisture of ink evaporates, the lower the ambient humidity, the more the viscosity of ink tends to increase through evaporation. Therefore, it is necessary to increase the circulation flow velocity.

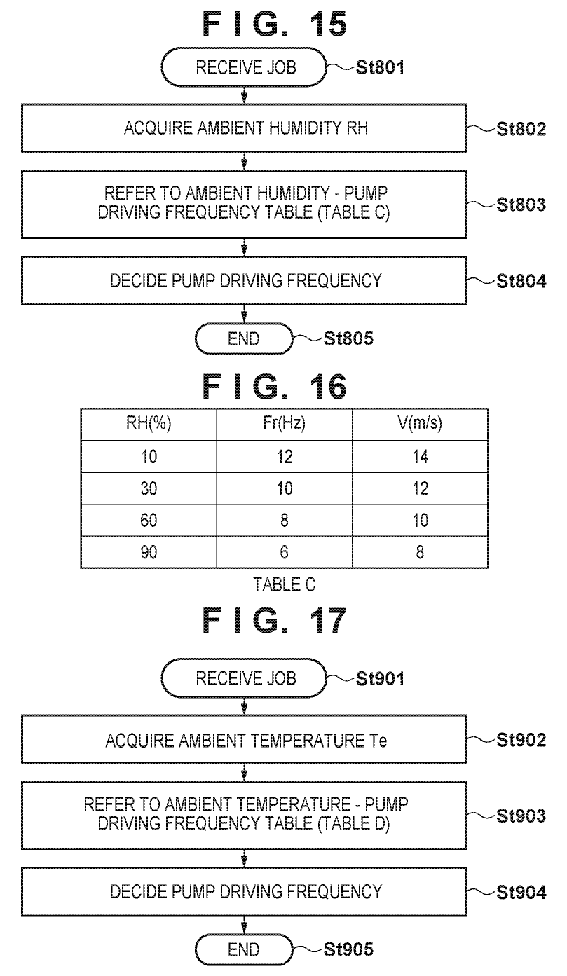

FIG. 15 shows a flowchart of a method of controlling the circulation flow velocity according to the third example.

In step St801, a print job transmitted from the host computer H0 is received and the method is started.

In step St802, the temperature/humidity sensor 906 acquires the ambient humidity of the liquid discharge apparatus 50 as an ambient humidity RH.

In step St803, a table C exemplarily shown in FIG. 16 is referred to. In step St804, the driving frequency Fr of the circulation pump 500 corresponding to the ambient humidity RH acquired in step St802 is decided. In step St805, the method ends. Similar to the tables A and B described in the first and second examples, respectively, the table C is stored in the ROM 902. The table C is preset with the driving frequency Fr of the circulation pump 500 corresponding to arbitrary ambient humidity RH. Thus, an effect similar to the effect in the first example can be achieved.

### Fourth Example

In the first to third examples described above, the ink circulation in the printing operation has been described. On the other hand, in a nonprinting operation (for example, before the liquid discharge head 1 is driven or while the liquid discharge head 1 is capped), ink components are deposited in the circulation path. To prevent this, ink circulation is performed even in the nonprinting operation.

In the nonprinting operation, the viscosity of ink in the circulation path substantially depends on the ambient temperature. Therefore, in the nonprinting operation, the driving frequency Fr of the circulation pump 500 can be calculated based on the detection result of ambient temperature.

FIG. 17 shows a flowchart of a method of controlling the circulation flow velocity according to the fourth example.

In step St901, a print job transmitted from the host computer H0 is received and the method is started.

In step St902, the temperature/humidity sensor 906 acquires the ambient temperature of the liquid discharge apparatus 50 as the ambient temperature Te.

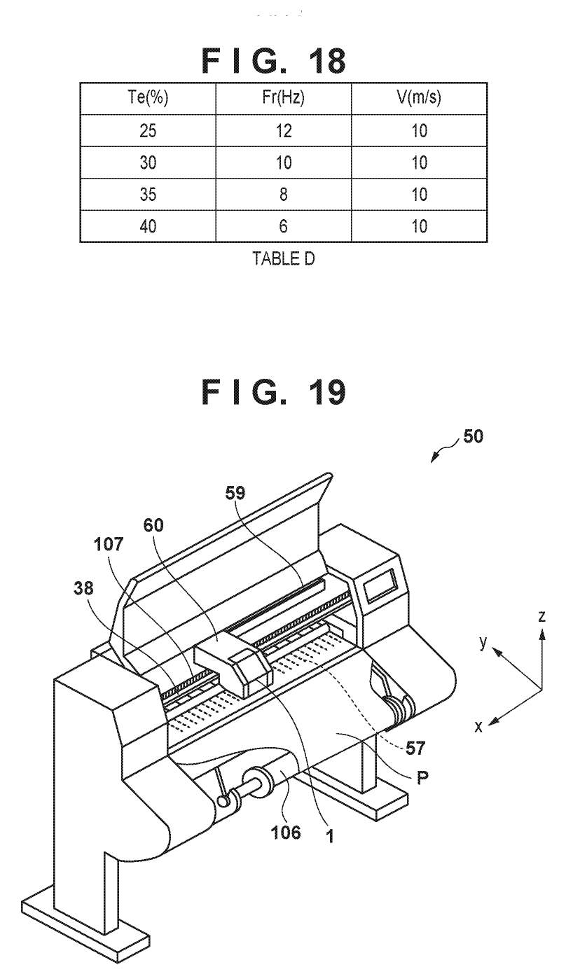

In step St903, a table D exemplarily shown in FIG. 18 is referred to. In step St904, the driving frequency Fr of the circulation pump 500 corresponding to the ambient temperature Te acquired in step St902 is decided. In step St905, the method ends.

Here, in the nonprinting operation, the liquid discharge head 1 is capped. However, since the viscosity of ink is reduced as the ambient temperature Te rises, the driving frequency Fr required to achieve the target circulation flow velocity V decreases. Therefore, in the nonprinting operation, to achieve the target circulation flow velocity V, the driving frequency Fr is decided based on the ambient temperature Te. In this example (the example using the table D), the target value for the circulation flow velocity V is set to V = 10 [m/s] regardless of the ambient temperature Te, and the driving frequency Fr required to achieve this is set for each ambient temperature Te. This enables appropriate ink circulation in the nonprinting operation as well. Thus, deposition of ink components can be prevented/eliminated, and print quality can be improved.

According to the above-described embodiment, power saving can be achieved while maintaining print quality. Particularly, when the liquid discharge head 1 is a serial head that often requires longer printing time than a line head, a significant effect can be obtained.

### Program

The present disclosure may be implemented by supplying a program that implements one or more functions of the above-described embodiment to a system or an apparatus via a network or a storage medium and reading out the program by one or more processors in the computer of the system or the apparatus and executing it. For example, the present disclosure may be implemented by a circuit (for example, an ASIC) that implements one or more functions.

In the embodiments, each element is named by an expression based on its main function, but the function described in the embodiments may be a sub function, and the expression is not strictly limited. Also, the expression can be replaced with another expression.

Also, two or more elements selectively exemplified in the embodiments are not strictly limited to the exemplification and may be combined arbitrarily. For example, each of the two or more exemplified elements may be additionally selected or alternatively selected. As an example, when arbitrarily combining two elements A and B, an expression "A and/or B" or an expression "at least one of A and B" may be used to indicate only A, only B, or both A and B.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025-004943, filed January 14, 2025, which is hereby incorporated by reference herein in its entirety.

What is claimed is:

1. A liquid discharge apparatus comprising:
a liquid discharge head;
a circulation mechanism comprising a circulation pump configured to circulate a liquid through a circulation path passing through the liquid discharge head; and
a sensor arranged in the apparatus, and configured to detect temperature,
wherein the circulation pump is configured to be driven at a frequency based on a detection result of the sensor.

2. The liquid discharge apparatus according to claim 1, wherein
the sensor detects a temperature of the liquid discharge head.

3. The liquid discharge apparatus according to claim 1, wherein
the sensor detects an ambient temperature around the apparatus.

4. A liquid discharge apparatus comprising:
a liquid discharge head;
a circulation mechanism comprising a circulation pump configured to circulate a liquid through a circulation path passing through the liquid discharge head; and
a sensor arranged in the apparatus, and configured to detect humidity,
wherein the circulation pump is configured to be driven at a frequency based on a detection result of the sensor.

5. The liquid discharge apparatus according to claim 1, further comprising:
a referring unit configured to refer to a table, wherein the table is preset with at least one frequency corresponding to the detection result; and
a driving unit configured to drive, based on a reference result of the referring unit, the circulation pump at the frequency corresponding to the detection result.

6. The liquid discharge apparatus according to claim 1, wherein
the liquid discharge head is configured to discharge a plurality of types of liquids, and
the circulation mechanism is configured to circulate each of the plurality of types of liquids.

7. The liquid discharge apparatus according to claim 2, wherein
the liquid discharge head is a print head configured to perform printing by discharging ink from a nozzle,
in a nonprinting operation, the nozzle is capped,
in a printing operation, the capping is released, and
the circulation pump is driven in the printing operation.

8. The liquid discharge apparatus according to claim 7, wherein
the liquid discharge head includes an electrothermal transducer configured to discharge ink from the nozzle.

9. The liquid discharge apparatus according to claim 8, wherein
the liquid discharge head is a serial head.

10. The liquid discharge apparatus according to claim 4, wherein
the liquid discharge head is a print head configured to perform printing by discharging ink from a nozzle,
in a nonprinting operation, nozzle is capped,
in a printing operation, the capping is released, and
the circulation pump is driven in both the nonprinting operation and the printing operation.

11. The liquid discharge apparatus according to claim 10, wherein
the liquid discharge head includes an electrothermal transducer configured to discharge ink from the nozzle.

12. The liquid discharge apparatus according to claim 11, wherein
the liquid discharge head is a serial head.
